(19) United States
(12) Patent Application Publication
(10) Pub. No.: US 2025/0252316 A1
(43) Pub. Date: Aug. 7, 2025

(54) APPARATUS AND METHOD FOR SEARCHING FOR DATA OF MUTI-AGENT REINFORCEMENT LEARNING

(71) Applicant: ELECTRONICS AND TELECOMMUNICATIONS RESEARCH INSTITUTE, Daejeon (KR)

(72) Inventors: Byunghyun Yoo, Daejeon (KR); Hyun Woo Kim, Daejeon (KR); Seungwoo Seo, Daejeon (KR); Hwa Jeon Song, Daejeon (KR); Younghwan SHIN, Daejeon (KR); Jeongmin Yang, Daejeon (KR); Sungwon Yi, Daejeon (KR); Euisok Chung, Daejeon (KR)

(21) Appl. No.: 19/032,706

(22) Filed: Jan. 21, 2025

(30) Foreign Application Priority Data
Feb. 2, 2024 (KR) 10-2024-0016654

(51) Int. Cl. G06N 3/092; G06N 3/045

(52) U.S. Cl. CPC G06N 3/092; G06N 3/045

(57) ABSTRACT

Provided is an apparatus for searching for training data of multi-agents, the apparatus including: a prediction module that predicts a current episode length based on states and actions of multi-agents; and a calculation module that calculates an intrinsic reward based on a prediction error of the prediction module, wherein the intrinsic reward is used for multi-agent reinforcement learning together with an external reward according to an environment.

### CROSS-REFERENCE TO RELATED APPLICATION

This application claims priority to and the benefit of Korean Patent Application No. 10-2024-0016654, filed on Feb. 2, 2024, the disclosure of which is incorporated herein by reference in its entirety.

### BACKGROUND

### 1. Field of the Invention

Various embodiments disclosed in this document relate to a multi-agent reinforcement learning technique.

### 2. Description of Related Art

Recently, in environments for autonomous vehicles, unmanned aerial vehicles, drones, or service robots, multi-agents are widely used. In the environments, multi-agent reinforcement learning technology is mainly used to optimize the collaboration or competition strategy between agents.

Multi-agent reinforcement learning is a technology in which multiple agents in a given environment learn action policies that obtain high rewards through collaboration or competition. In multi-agent reinforcement learning, the number of states and actions exponentially increases with the number of agents. Therefore, in the multi-agent reinforcement learning, it is required to efficiently select various states and actions and learn the optimal policy. A representative technique is a curiosity-based search technique.

The curiosity-based search technique defines an error between a predicted value and an actual value of the next state as curiosity and uses the curiosity value as an intrinsic reward in the learning process. The curiosity-based search technique provides a higher intrinsic reward in proportion to a difference between the predicted value and the actual value of the next state and increases the frequency of selecting the action. Therefore, the curiosity-based search technique shows excellent performance in single-agent environments, particularly in environments in which rewards rarely occur.

### SUMMARY OF THE INVENTION

Curiosity-based search techniques produce a higher intrinsic reward in proportion to a difference between a predicted value and an actual value of a state. Therefore, the curiosity-based search techniques may be less suitable for a multi-agent environment in which, due to a large number of states and actions, similar results are provided in different states. Specifically, curiosity-based search techniques that provide rewards for state changes may repeatedly collect experiences that show similar results in different states. In terms of learning for multi-agents, it is beneficial to collect experiences that show various results, but curiosity-based search techniques in multi-agent reinforcement learning may repeat meaningless learning of similar results.

The disclosure is directed to providing an apparatus and method for searching for data of multi-agent reinforcement learning that are capable of searching for training data based on episode characteristics.

According to an aspect of the present disclosure, there is provided an apparatus for searching for training data of multi-agents, which includes: a prediction module that predicts a current episode length based on states and actions of multi-agents; and a calculation module that calculates an intrinsic reward based on a prediction error of the prediction module, wherein the intrinsic reward is used for multi-agent reinforcement learning together with an external reward according to an environment.

According to an aspect of the present disclosure, there is provided an apparatus for searching for training data of multi-agents, which includes: a memory in which at least one instruction is stored; and a processor functionally connected to the memory, wherein the processor executes the at least one instruction to: predict a current episode length based on states and actions of multi-agents; and calculate an intrinsic reward based on a prediction error of the episode length, wherein the intrinsic reward is used for multi-agent reinforcement learning together with an external reward according to an environment.

According to an aspect of the present disclosure, there is provided a method of searching for training data of multi-agents, which includes: predicting a current episode length based on states and actions of multi-agents; and calculating an intrinsic reward based on a prediction error of the prediction module, wherein the intrinsic reward is used for multi-agent reinforcement learning together with an external reward according to an environment.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a configuration of a computer system for implementing a method of searching for data of a multi-agent reinforcement learning according to an embodiment;

FIG. 2 is a block diagram illustrating a configuration of an apparatus for searching for training data according to an embodiment;

FIG. 3 is a block diagram illustrating a detailed configuration of a prediction module according to an embodiment;

FIG. 4 is a block diagram illustrating a detailed configuration of a calculation module according to an embodiment; and

FIG. 5 is a flowchart showing a method of searching for training data according to an embodiment.

In relation to the description of the drawings, identical or similar reference numerals may be used for identical or similar components.

### DETAILED DESCRIPTION OF EXEMPLARY EMBODIMENTS

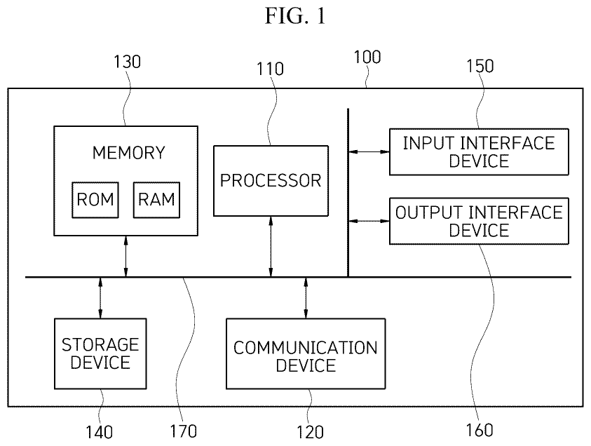

FIG. 1 is a block diagram illustrating a configuration of a computer system for implementing a method of searching for data of a multi-agent reinforcement learning according to an embodiment.

Referring to FIG. 1, a computer system 100 may include at least one of a processor 110, a memory 130, an input interface device 150, an output interface device 160, and a storage device 140 that communicate through a bus 170. The computer system 100 may further include a communication device 120 coupled to a network.

The memory 130 and the storage device 140 may include various forms of volatile or nonvolatile media. For example, the memory may include a read only memory (ROM) or a random access memory (RAM). In an embodiment, the memory 130 may be located inside or outside the processor and may be connected to the processor 110 through various known means. The memory 130 may include various forms of volatile or nonvolatile media, for example, may include a ROM or a RAM. The memory 130 may store various types of data used by at least one component (e.g., the processor 110) of the computer system 100. The data may include, for example, input data or output data for software and instructions related thereto. For example, the memory 130 may store at least one instruction for a training data collection service. The at least one instruction may, when executed, cause the processor 110 to predict a current episode length based on states and actions of multi-agents, and to calculate an intrinsic reward based on a prediction error of the episode length. The intrinsic reward may be used for multi-agent reinforcement learning together with an external reward according to an environment.

The processor 110 may be a central processing unit (CPU) or a semiconductor device for executing instructions stored in the memory 130 and/or storage device 140. The processor 1100 may control at least one other component (e.g., a hardware or software component) of the computer system 100 and may perform processing or operation on various types of data. The processor 110 may include, for example, at least one of a CPU, a graphics processing unit (GPU), a microprocessor, an application processor, an application specific integrated circuit (ASIC), and a field programmable gate array (FPGA), and may have a plurality of cores. The processor 110 may execute at least one instruction, to calculate an intrinsic error based on a prediction error of the episode length.

According to an embodiment, the processor 110 may condense and encode the history of all previous states and actions through a recurrent neural network, encode a current state and a current action through an encoding neural network, and predict the episode length through a prediction neural network based on all of the states and the actions encoded by the recurrent neural network and the encoding neural network. The episode may be a sequence of time steps of environmental changes and rewards that occur as each agent selects an action. In this regard, the processor 110 may model the prediction neural network by learning of a mean square error between a predicted value and an actual value of the episode length.

According to an embodiment, the processor 110 may set a scale factor such that a ratio of an intrinsic reward to an external reward is within a designated range and may correct the prediction error using the set scale factor to calculate the intrinsic reward. For example, the processor 110 may calculate the average values of a designated number of prediction errors and a designated number of external rewards at a designated initial learning stage. The processor 110 may set the scale factor of the prediction error such that the intrinsic reward is 1.5 to 2 times the external reward based on a ratio of the average of the prediction errors to the average of the external rewards. The processor 110 may update the scale factor such that after the initial learning stage, the ratio of the intrinsic reward to the external reward becomes closer to 1 (e.g., a ratio=1) compared to the initial learning stage. The scale factor at the initial learning stage may be set by the user according to the environment and the range of variation of each reward.

According to an embodiment, the computer system 100 focuses on an environment in which each episode ends within a finite time and the end time of the episode may vary depending on the action of each agent. The computer system 100 may perform search using a prediction error of the episode length when rewards rarely occur in such an environment. Since the end time of the episode varies depending on the states and actions of multi-agents, policies with different episode lengths are likely to take different action strategies. In this respect, the computer system 100 according to an embodiment is provided to predict when the current episode ends, calculate an error between the predicted episode end time and an actual episode end time, and use the error as an intrinsic reward for the search technique.

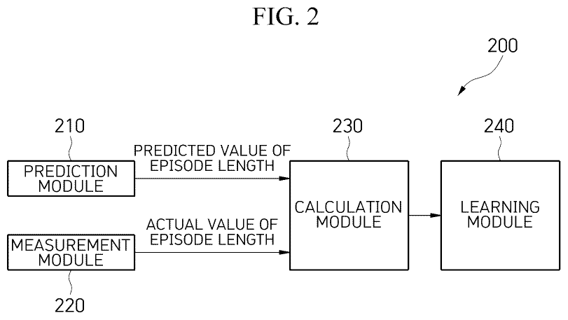

FIG. 2 is a block diagram illustrating a configuration of an apparatus for searching for training data according to an embodiment.

Referring to FIG. 2, an apparatus 200 for searching for training data according to an embodiment may include a prediction module 210, a measurement module 220, a calculation module 230, and a learning module 240. The prediction module 210, the measurement module 220, the calculation module 230, and the learning module 240 may be a software module included in the processor 110 or executed by the processor 110. In an embodiment, in the apparatus 200 for searching for training data, some components may be omitted or additional components may be added. For example, the learning module 240 may be omitted. In addition, some of the components of the apparatus 200 for searching for training data may be combined into a single component that may perform the same functions of the components before the combination.

According to an embodiment, the prediction module 210 may obtain a state and an action of each agent as an input and predict the end point of the current episode (or the current episode length) based on the obtained state and action. The episode length may be affected not only by the current state and the current action but also by the previous history. Therefore, the prediction module 210 may encode the history of previous states and actions, and the current state and action to predict the episode length based on all of the encoded states and actions.

In an embodiment, the prediction module 210 may predict the episode length using an encoding neural network, which is modeled by the results of episode length learning for the previous and current states and actions. For example, the prediction module 210 may be modeled through learning that calculates the mean square error between a predicted value and an actual value of the episode length and minimizes the calculated mean square error.

In an embodiment, the measurement module 220 may measure the current episode length while each agent is selecting an action. When each episode ends upon achieving a designated goal or satisfying a designated condition, the measurement module 220 may calculate an actual value of the ended episode length. Each episode may include, for example, interactions of an agent starting from an initial state until a specific end condition or goal is achieved. The episode length may be, for example, the number of steps taken until an episode is completed as each agent interacts with an environment through a series of actions and achieves the specific end condition or the goal.

In an embodiment, the calculation module 230 may calculate a prediction error corresponding to the difference between the predicted value and the actual value of the episode length. The calculation module 230 may convert the prediction error into an intrinsic reward by applying a designated operation to the calculate prediction error. For example, the calculation module 230 may calculate an intrinsic reward by multiplying the prediction error by a designated scale factor. The designated scale factor may be determining for example, by calculating a designated number of external rewards and intrinsic rewards based on the states and actions of each agent at the initial stage of learning, and ensuring that the difference between the external reward and the intrinsic reward is within a designated range (e.g., 1.5 to 2 times). The external reward may be, for example, a reward obtained from a multi-agent environment in a reinforcement learning process through multi-agents.

In an embodiment, the learning module 240 may perform multi-agent reinforcement learning using the external reward and the intrinsic reward. For example, the learning module 240 may learn a joint action-value function, which is one of the goals of multi-agent reinforcement learning, using the intrinsic reward and the extrinsic reward. The joint action-value function is a function that estimates an expected cumulative reward based on states, actions, and previous histories of all agents as an input.

The learning module 240 may use a value decomposition method, which is a representative technique of multi-agent reinforcement learning. In the value decomposition method, the joint action-value function is a function of an individual action-value function, as shown in the following Equation 1.

$${Q}_{jt} = f ( {Q}_{i} ) \qquad [ Equation 1 ]$$

Here, Qⱼₜ is a joint action value function, and Qᵢ is an individual action value function. Each agent selects an action with the maximum value of individual action-value function value. In this case, as shown in the following Equation 2, the set of actions with the maximum individual action-value function value of each agent needs to be the same as the joint action that maximizes the joint action value function value. This condition is referred to as the individual-global-max (IGM) condition.

$${arg max}_{u} {Q}_{jt} ( τ , u ) = ( \begin{matrix}{arg max}_{{u}_{1}} {Q}_{1} ( {τ}_{1} , {u}_{1} ) \\ ⋮ \\ {arg max}_{{u}_{m}} {Q}_{m} ( {τ}_{m} , {u}_{m} )\end{matrix} ) \qquad [ Equation 2 ]$$

Here, τₘ is a history of observation information and an action of an m^{th} agent, uₘ is an action of the m^{th} agent, and τ is a history of observation information and actions of all agents.

The function ƒ in the above Equation 1 needs to satisfy the condition of Equation 3. The condition of Equation 3 may be difficult to apply to an actual model. Simply, the joint action value function is composed of the sum of individual action value functions and may utilize an intrinsic reward. After a loss function L for learning the joint action value function is set, the learning module 240 may learn the joint action value function as in Equation 3 and thereby learning the individual action value functions that constitute the joint action value function.

$$ℒ = {\sum }_{k = 1}^{b} {( {y}_{i}^{jt} - {Q}_{jt} ( τ , u , s ) )}^{2} \qquad [ Equation 3 ]$$

$${y}_{i}^{jt} = r + {r}_{i} + γ {max}_{u ′} {Q}_{jt} ( {τ}^{′} , {u}^{′} , {s}^{′} )$$

In the above Equation 3, γ is a discount factor used in reinforcement learning, s′ is a state at the next time, u′ is an action at the next time, τ′ is a history of observation information and actions of all agents at the next time, r is an external reward, and rᵢ is an intrinsic reward.

As described above, the apparatus 200 for searching for training data according to an embodiment may support the learning module 240 in generating an episode of a new length by predicting an episode length in a multi-agent environment and calculating an intrinsic reward based on a prediction error.

In addition, the apparatus 200 for searching for training data according to an embodiment may guide the agent to experience episodes of various lengths under the assumption that actions with different episode lengths basically take different strategies, and thus may support a wider range of search compared to the related art of curiosity-based search technique that simply focuses on a new state.

Furthermore, the apparatus 200 for searching for training data according to an embodiment may perform search using information that may be obtained separately from the external reward, such as the episode length, and the information may be used regardless of the frequency of reward occurrences. Therefore, it is possible to search for training data even in an environment in which rewards rarely occur and learning is more difficult.

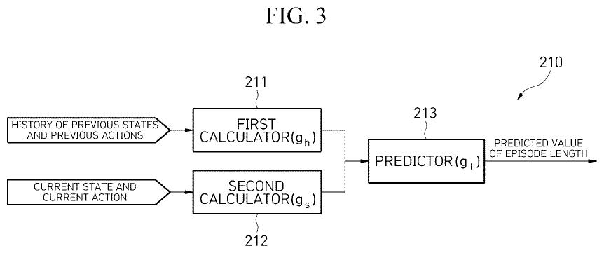

FIG. 3 is a block diagram illustrating a detailed configuration of a prediction module according to an embodiment.

Referring to FIG. 3, the prediction module 210 according to an embodiment may include a first encoder 211, a second encoder 212, and a predictor 213.

According to an embodiment, the first encoder 211 may encode and condense the history of all previous states and actions. The first encoder 211 may obtain all previous actions (i.e., the joint action) and states of multi-agents as an input and condense and encode all of the input previous states and actions.

$${h}_{t - 1} = {g}_{h} ( {s}_{1} , {u}_{1} , … {s}_{t - 1} , {u}_{t - 1} ) \qquad [ Equation 4 ]$$

In the above Equation 4, t is a time, s is a state, u is an action of all agents (a joint action), h is a previous history, and gₕ may be a neural network for information reduction and encoding of previous states and actions.

The first encoder 211 may encode and then condense the history of previous states and actions based on a neural network model gₕ that condenses previous history information, such as a recurrent neural network. As described above, the first encoder 211 according to an embodiment may express factors for the previous history as one factor for all previous states and actions at each time using the recurrent neural network, thereby preventing inefficient calculation.

According to an embodiment, the second encoder 212 may encode current states and actions of each agent. The second encoder 212 may be, for example, a neural network that encodes input current states and actions.

According to an embodiment, the predictor 213 may calculate the remaining length until the end of the episode based on the actual value check of the episode length or the time points of states and actions related to the prediction of the episode length.

The predictor 213 may obtain an output hₜ₋₁ of the first encoder 211 and an output gₛ(sₜ, uₜ) of the second encoder 212 as an input, and may calculate a predicted value \hat{L} of the current episode length based on all of the encoded previous and current states and actions as shown in Equation 5.

$$= {g}_{l} ( {g}_{s} ( {s}_{t} , {u}_{t} ) , {h}_{t - 1} ) \qquad [ Equation 5 ]$$

In the above expression 5, t is a time, s is a state, u is an action of all agents (a joint action), h is a previous history, \hat{L} is a predicted value of an episode length, gₛ is an encoding neural network for a current state and a current action, and gₗ is a neural network model (i.e., a predictor 213) for predicting an episode length.

According to an embodiment, the predictor 213 (or a neural network gₗ for predicting an episode length) may be modeled through learning that minimizes the mean square error between a predicted value [symbol] and an actual value Lₜ of an episode length as shown in the following Equation 6.

For example, the predictor 213 may calculate a predicted value of an episode length based on all current and previous states and actions of the multi-agents and obtain a prediction error between the predicted value of the episode length and an actual value of the episode length from the measurement module 220. The predictor 213 may model the neural network gₗ by repeating the calculation of the mean square error between the actual value and the predicted value of the episode length as many times as the number b of training data. The predictor 213 may be modeled to, when obtaining a prediction error from the calculation module 230 during reinforcement learning, gradually reduce the prediction error.

$${\sum }_{k = 1}^{b} {( {L}_{t} - )}^{2} \qquad [ Equation 6 ]$$

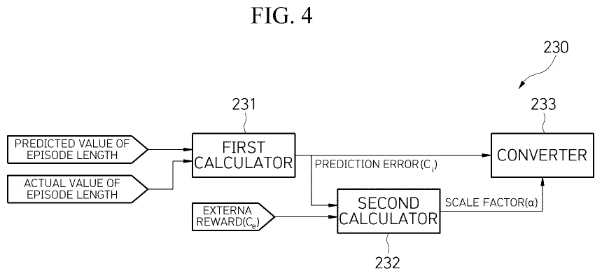

FIG. 4 is a block diagram illustrating a detailed configuration of a calculation module according to an embodiment.

Referring to FIG. 4, a calculation module 230 according to an embodiment may include a first calculator 231, a second calculator 232, and a converter 233.

The first calculator 231 may calculate a difference (a prediction error) between a predicted value and an actual value of an episode length. For example, the first calculator 231 may calculate an absolute value of a difference between a predicted value and an actual value of an episode length.

The second calculator 232 may check a ratio of the prediction error to an external reward and may calculate a scale factor of the prediction error such that the checked ratio is within a designated error range. The scale factor may be a factor that is multiplied by the prediction error such that the difference between the intrinsic reward and the extrinsic reward is within a designated range.

For example, the second calculator 232 may check an external reward value γ and a prediction error value |Lₜ− [symbol] | using a designated number (e.g., 10) of training data at the initial stage of learning. The second calculator 232 may calculate the first and second average values Cₑ and Cᵢ of the designated number of external reward values and the designated number of prediction error values, as shown in the following Equation 7.

$${C}_{e} = \frac{1}{N} {\sum }_{k = 1}^{N} r , {C}_{i} = \frac{1}{N} {\sum }_{k = 1}^{N} \vert L - \hat{L} \vert \qquad [ Equation 7 ]$$

The second calculator 232 may set the scale factor such that the first average of intrinsic rewards Cᵢ becomes twice the second average of external rewards Cₑ at the initial stage of learning. For example, the second calculator 232 may set the scale factor α by dividing the external reward by the prediction error value (or first average of intrinsic rewords) multiplied by 2 at the initial stage of learning, as shown in the following Equation 8. However, it is not limited thereto. For example, in a special environment or an environment with a large range of reward variations, the scale factor may be adjusted, for example, by the user.

$$α = \frac{{C}_{e}}{2 {C}_{i}} \qquad [ Equation 8 ]$$

The second calculator 232 may adjust the scale factor according to the ratio of the prediction error to the external reward. For example, when learning about the states and actions of the multi-agents progresses to a certain extent and search has been extensively performed, the prediction error of the prediction module 210 may gradually decrease. In this case, the second calculator 232 may adjust the scale factor such that the ratio of the prediction error to the external reward is within a designated range.

The converter 233 may obtain the scale factor from the second calculator 232 and multiply the scale factor by the prediction error to calculate an intrinsic reward value γᵢ as shown in the following Equation 9.

$${r}_{i} = α \vert L - \hat{L} \vert \qquad [ Equation 9 ]$$

As described above, the apparatus 200 for searching for training data according to an embodiment may support the learning module in generating an episode of a new length by predicting an episode length in a multi-agent environment and calculating an intrinsic reward based on a prediction error.

In addition, the apparatus 200 for searching for training data according to an embodiment may guide the agent to experience episodes of various lengths under the assumption that actions with different episode lengths basically take different strategies, and thus may support a wider range of search compared to the related art of curiosity-based search technique that simply focuses on a new state.

Furthermore, the apparatus 200 for searching for training data according to an embodiment may perform search using information that may be obtained separately from the external reward, such as the episode length, and the information may be used regardless of the frequency of reward occurrences. Therefore, it is possible to search for training data even in an environment in which rewards rarely occur and learning is difficult.

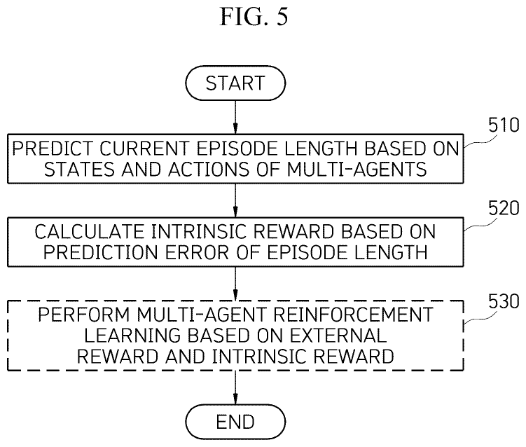

FIG. 5 is a flowchart showing a method of searching for training data according to an embodiment.

Referring to FIG. 5, in operation 510, the apparatus 200 for searching for training data may predict a current episode length based on states and actions of multi-agents. For example, the apparatus 200 for searching for training data may condense and encode the history of all previous states and actions through a recurrent neural network and encode a current state and a current action through an encoding neural network. The apparatus 200 for searching for training data may predict the episode length through a prediction neural network based on all of the states and the actions encoded by the recurrent neural network and the encoding neural network.

In operation 520, the apparatus 200 for searching for training data may calculate an intrinsic reward based on a prediction error of the episode length. For example, the apparatus 200 for searching for training data may set a scale factor such that the ratio of the intrinsic reward to the external reward is within a designated range and correct the prediction error using the set scale factor to calculate the intrinsic reward.

In operation 530, the apparatus 200 for searching for training data may learn the action value function of the multi-agents using the intrinsic reward together with the external reward according to the environment.

As described above, the apparatus 200 for searching for training data according to an embodiment may support the learning module in generating an episode of a new length and performing a wider range of search by predicting an episode length in a multi-agent environment and calculating an intrinsic reward based on the prediction error.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a” and “an” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc. are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., an internal memory or external memory,) that can be read by a machine (e.g., the apparatus for geofencing service). For example, a processor (e.g., the processor 110 of the machine (e.g., the apparatus 200 for searching for training data) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure 0 may be implemented in the form of software or hardware, such as a digital signal processor (DSP), a FPGA or an ASIC, and may perform predetermined functions. The “elements” are not limited to meaning software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of a program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

As is apparent from the above, according to various embodiments disclosed in this document, training data can be found based on episode characteristics (e.g., a length). In addition, various effects directly or indirectly identified through this document can be provided.

What is claimed is:

1. An apparatus for searching for training data of multi-agents, the apparatus comprising:
a prediction module predicting a current episode length based on states and actions of multi-agents; and
a calculation module calculating an intrinsic reward based on a prediction error of the prediction module,
wherein the intrinsic reward is used for multi-agent reinforcement learning together with an external reward according to an environment.

2. The apparatus of claim 1, wherein the prediction module includes:
a first encoder condensing and encoding a history of all previous states and actions;
a second encoder encoding a current state and a current action; and
a predictor predicting the episode length based on all of the states and the actions encoded by the first encoder and the second encoder.

3. The apparatus of claim 2, wherein each of the first encoder and the second encoder is a neural network that encodes a joint action of all previous agents or current agents.

4. The apparatus of claim 2, wherein the second encoder includes a recurrent neural network which sequentially encodes the history of all the previous states and actions.

5. The apparatus of claim 1, wherein the calculation module calculates a difference between a predicted value and an actual value of the episode length as the prediction error and applies a designated operation to the prediction error to calculate the intrinsic reward.

6. The apparatus of claim 5, wherein the prediction module is modeled by learning a mean square error between the predicted value and the actual value.

7. The apparatus of claim 1, wherein the calculation module applies a scale factor to the prediction error to calculate the intrinsic reward.

8. The apparatus of claim 7, wherein the calculation module determines and corrects the scale factor so that a ratio of the intrinsic reward to the external reward is within a designated range.

9. The apparatus of claim 8, wherein the calculation module respectively calculates a first and a second average values of a designated number of prediction errors and external rewards at an initial stage of a designated learning, and sets the scale factor of the prediction error such that the intrinsic reward is 1.5 to 2 times the external reward based on a ratio of the first average value to the second average value.

10. The apparatus of claim 9, wherein the calculation module updates the scale factor such that, after the initial stage of the learning, the ratio of the intrinsic reward to the external reward becomes closer to 1 compared to the initial stage of the learning.

11. The apparatus of claim 9, wherein the scale factor at the initial stage of the learning is adjusted by a user according to the environment and a variation range of each reward.

12. The apparatus of claim 5, further comprising a learning module which learns an action value function of the multi-agents based on the calculated intrinsic reward and the external reward.

13. An apparatus for searching for training data of multi-agents, the apparatus comprising:
a memory in which at least one instruction is stored; and
a processor functionally connected to the memory,
wherein the processor executes the at least one instruction to:
predict a current episode length based on states and actions of multi-agents; and
calculate an intrinsic reward based on a prediction error of the episode length,
wherein the intrinsic reward is used for multi-agent reinforcement learning together with an external reward according to an environment.

14. The apparatus of claim 13, wherein the processor executes the at least one instruction to:
condense and encode a history of all previous states and actions through a recurrent neural network;
encode a current state and a current action through an encoding neural network; and
predict the episode length through a prediction neural network based on all of the states and the actions encoded by the recurrent neural network and the encoding neural network.

15. The apparatus of claim 14, wherein the processor executes the at least one instruction to model the prediction neural network by learning a mean square error between a predicted value and an actual value of the episode length.

16. The apparatus of claim 13, wherein the processor executes the at least one instruction to:
set a scale factor that allows a ratio of the intrinsic reward to the external reward to be within a designated range; and
correct the prediction error using the set scale factor to calculate the intrinsic reward.

17. A method of searching for training data of multi-agents, the method comprising:
predicting a current episode length based on states and actions of multi-agents; and
calculating an intrinsic reward based on a prediction error of the episode length,
wherein the intrinsic reward is used for multi-agent reinforcement learning together with an external reward according to an environment.

18. The method of claim 17, wherein the predicting includes:
condensing and encoding a history of all previous states and actions through a recurrent neural network;
encoding a current state and a current action through an encoding neural network; and
predicting the episode length through a prediction neural network based on all of the states and the actions encoded by the recurrent neural network and the encoding neural network.

19. The method of claim 17, further comprising modeling the prediction neural network by learning a mean square error between a predicted value and an actual value of the episode length.

20. The method of claim 17, wherein the calculating includes:
setting a scale factor that allows a ratio of the intrinsic reward to the external reward to be within a designated range; and
correcting the prediction error using the set scale factor, to calculate the intrinsic reward.
